(19) United States
(12) Patent Application Publication
(10) Pub. No.: US 2007/0163313 A1
(43) Pub. Date: Jul. 19, 2007

(54) Vehicle Lock

(76) Inventor: Oscar A. Zamora, Sun Valley, CA (US)

Correspondence Address: ADVANTIA LAW GROUP, 9035 SOUTH 1300 EAST, SUITE 200, SANDY, UT, 84094, US

(21) Appl. No.: 11/306,994

(22) Filed: Jan. 18, 2006

(51) Int. Cl. B60R 25/00; E05B 65/12

(52) U.S. Cl. 70/237

(57) ABSTRACT

A vehicle lock for inhibiting unwanted intrusion into a vehicle, wherein the key acceptor and key hole are smaller than typical key acceptors and key holes to restrict what can be inserted into the key hole, such that tools typically used to gain unauthorized entry into a vehicle by insertion into the key hole cannot be used to gain entry into a vehicle using a vehicle lock of the present invention. The vehicle lock includes a key acceptor which is at least partially encircled by a spacer. Also disclosed is a kit for retrofitting an existing vehicle with a vehicle lock according to the present invention.

### FIELD OF THE INVENTION

The present invention relates generally to vehicle locks and, more particularly, to vehicle locks for inhibiting unwanted intrusion.

### Description of the Related Art

The art of vehicle locking includes several mechanisms for stopping unwanted intrusion into the vehicle. Several examples exist of techniques for locking vehicle doors. For example, U.S. Pat. No. 5,676,002 to Hoeptner discloses unlocking of a vehicle door by insertion of implements other than the door key into the door is prevented by a guard housing within the door into which the key turnable inner end of the lock cylinder extends and which also encloses an otherwise vulnerable portion of the linkage which interconnects the lock cylinder and the door latching means. In a preferred form of the invention, the housing has an extension which extends below the lock cylinder and which is angled to extend to the outer shell of the door and then downward along the inner surface of the shell and which extends between the shell and the side impact beam of the door. The guard may secured in place by the same bolt that secures the handle assembly to the door and is wholly within and concealed by the door.

Further, U.S. Pat. No. 4,508,379 to Mochida discloses a door locking device having a high anti-theft performance. The device comprises a catching device mounted in the door and including a hook member and a lever member, the hook member being locked when the lever member is moved in a direction and unlocked when the lever is moved in an opposite direction; a key cylinder rotatably mounted to the door, the key cylinder being rotatable about the axis thereof only when handled by a specified key; an arm securely connected to an end of the key cylinder and extending therefrom radially outwardly; a rod pivotally connected to the arm and extending therefrom toward the lever member, so that rotation of the key cylinder about the axis thereof induces an axial movement of the rod; and a play providing device interposed between the extending end of the rod and the lever member, so that a play is permitted between the rod and the lever member upon relative movement therebetween.

Furthermore, Krügener discloses in U.S. Pat. No. 4,237,709 a locking mechanism for lids, hoods, flaps and/or doors, especially in motor vehicles, which cooperates with a cylinder lock whose lock cylinder is provided with a lock part adapted to be pressed-in against the force of a spring. The lock part includes, at its cylindrical outer surface, a pressure pin which is swung by rotation from an operating position to a non-operating position. In addition to the pressure pin, a lug is arranged at the outer surface of the lock part adapted to be pressed-in. The lug is operatively connected with an additional locking mechanism in such a manner that the additional locking mechanism becomes operable only over a limited rotary range of the lock cylinder adjoining the inoperable position of the pressure pin—as viewed in the locking direction.

The currently available locking mechanisms for vehicles do not solve all of the problem of unwanted entry, however. Thieves often enter cars regardless of the locking mechanism by forcing a flattened rod such as a flat-head screwdriver into the key slot and turning the rod to unlock the mechanism. The currently available locking mechanisms do not address this problem.

What is needed is a vehicle lock that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available vehicle locks. According to one embodiment, the present invention has been developed to provide a vehicle lock for inhibiting unwanted intrusion into a vehicle, comprising a key acceptor which includes a hey hole for the insertion of a key, a spacer extending coaxially with the key acceptor, and encompassing at least a portion of the key acceptor, a link arm rotatably connected to the key acceptor, and a lock arm, connected to the key acceptor such that upon rotation of the link arm, the lock arm causes the locking mechanism to change between locked and unlocked positions.

According to one embodiment, the key acceptor may be generally cylindrical in shape. The key acceptor may have a diameter of less than ⅓ inch.

According to yet another embodiment, the present invention discloses a vehicle lock kit that can be assembled in the field, for retrofitting vehicles with a vehicle lock mechanism for inhibiting unwanted intrusion into vehicles, the kit comprising a key acceptor which includes a hey hole for the insertion of a key, a spacer extending coaxially with the key acceptor, and encompassing at least a portion of the key acceptor, a link arm rotatably connected to the key acceptor, and a lock arm, connected to the key acceptor such that upon rotation of the link arm, the lock arm causes the locking mechanism to change between locked and unlocked positions.

According to still a further embodiment, the key acceptor may be generally cylindrical in shape. The key acceptor may have a diameter of less than ⅓ inch. The key hole may include a height of less than about ⅓ inch. The key acceptor may include a shaped portion that extends through the link arm. The shaped portion may further include a cutaway, and wherein the kit further includes a lock clip that clips onto the cutaway portion. The vehicle lock kit may further include a key shaped to fit into the key hole.

According to yet another embodiment, the present invention discloses a vehicle lock for inhibiting unwanted intrusion into a vehicle, consisting only of a key acceptor which includes a hey hole for the insertion of a key, a spacer extending coaxially with the key acceptor, and encompassing at least a portion of the key acceptor, a link arm rotatably connected to the key acceptor, and a lock arm, connected to the key acceptor such that upon rotation of the link arm, the lock arm causes the locking mechanism to change between locked and unlocked positions.

The key acceptor may be generally cylindrical in shape. The key acceptor may have a diameter of less than ⅓ inch. The key hole may have a height of less than about ⅓ inch.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a front cutaway plan view of a vehicle lock according to one embodiment of the present invention;

FIG. 2 illustrates a back perspective view of a vehicle lock according to one embodiment of the present invention;

FIG. 3 illustrates a back exploded perspective view of a vehicle lock according to one embodiment of the present invention;

FIG. 4 illustrates a side perspective view of a key for a vehicle lock according to one embodiment of the present invention;

FIG. 5 illustrates a front plan view of a key acceptor according to one embodiment of the present invention;

FIG. 6 illustrates a front plan view of a key acceptor according to one embodiment of the present invention; and

FIG. 7 illustrates a side plan view of a key acceptor according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

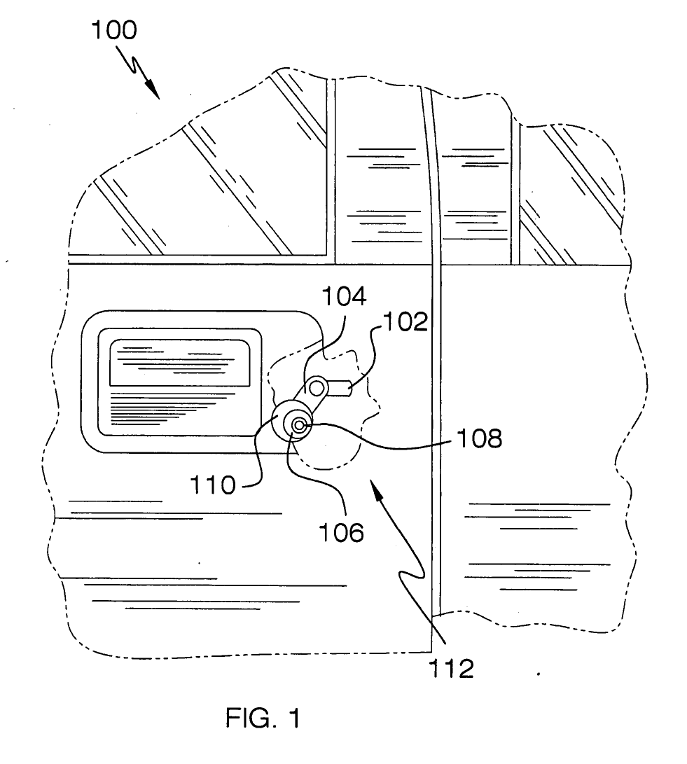

FIG. 1 illustrates a cutaway front plan view of the vehicle lock 112 according to one embodiment of the present invention. A vehicle is illustrated generally as 100. Vehicle locks 112 are typically found on several parts of a vehicle, such as, for example, a door, a trunk, and the like. In this illustrated example, the vehicle lock 112 is located in a vehicle door. The vehicle lock 112 of the presently illustrated embodiment includes a key acceptor 106 which includes a key hole 108. The key acceptor 106 is rotatably connected to a link arm 104, which is in turn connected to a lock arm 102. The key acceptor 106, link arm 104, and lock arm 102 are configured to, when rotated, either lock or unlock the door. The key acceptor 106, link arm 104, and lock arm 102 may be configured to unlock or lock the door using any mechanism known in the art. The key acceptor 106, however, will only turn if the key that is inserted into the acceptor is keyed to rotate the key acceptor 106. Further illustrated is a spacer 110 which may be a circular plate with a cut-out to accept the key acceptor 106. Alternatively, the spacer 110 may be a solid piece that extends into the vehicle lock 112.

In one embodiment, the key acceptor 106 is configured to accept a generally tubular-shaped key. The key that fits the key acceptor 106 may also be tubular-shaped.

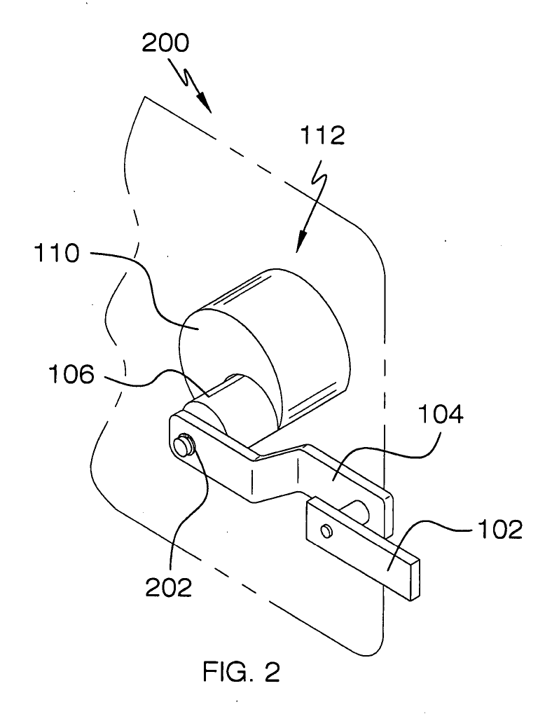

FIG. 2 illustrates a back perspective view of the vehicle lock 112 according to one embodiment of the present invention. Shown in this illustration is the spacer 110 as extending through the vehicle lock 110. The key acceptor 106 extends through the spacer, and is rotatably connected to the link arm 104 and the lock arm 102. The key acceptor 106 may have a portion that extends through the link arm 104, and is held in place by a lock clip 202.

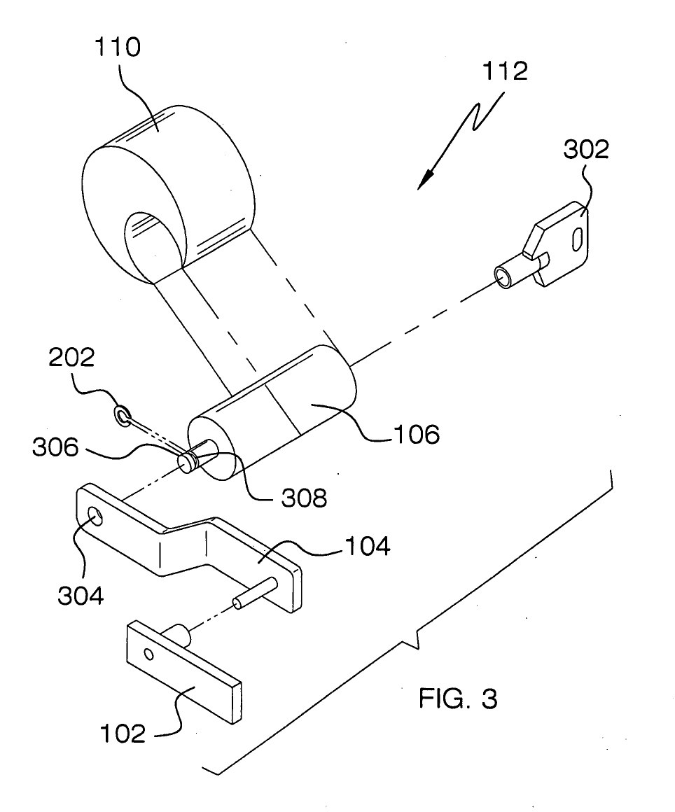

FIG. 3 illustrates an exploded view of the vehicle lock 112 according to another embodiment of the present invention. The vehicle lock 112 according to this embodiment includes a portion of the key acceptor 106 that extends through the link arm 104. This portion is shaped 306 such that when this portion is rotated, it causes the link arm 104 to rotate as well. In one embodiment, the shaped portion includes a flat spot. Further, the link arm 104 includes an aperture 304 shaped to correspond with the shaped portion 306.

The shaped portion 306 further may include a cutaway 308. When the shaped portion 306 is extended through the aperture 304, the cutaway 308 also extends through the aperture. Once the cutaway 308 is extended through the aperture 304, a lock clip 202 may be placed on the cutaway 308 such that the shaped portion 306 cannot be removed from the aperture without first removing the lock clip 202.

The lock arm 102 is also attached to the link arm 104. The lock arm 102 may be attached by any means known in the art. Further, the lock arm 102 may be any known in the art for locking and/or unlocking a vehicle door. In one embodiment, the lock arm 102 is a device that moves a locking mechanism inside of a vehicle door to the lock or the unlock position.

The key acceptor 106 may fit inside of a spacer 110. The spacer 110 may be designed to take up space inside of an existing vehicle lock mechanism. The key acceptor 106 of the present invention is smaller than the key acceptors of typical vehicle locks. Thus, if a vehicle is retrofitted with a vehicle lock of the present invention, the space between the new key acceptor 106 and where the old key acceptor used to be may be taken up by the spacer 110. The spacer 110 may be part of the key acceptor 106. The key acceptor 106 may include a mechanism that does not allow the link arm 104 to rotate unless the proper key is inserted. The mechanism may extend into, or be a part o the spacer 110.

Further illustrated in FIG. 3 is a key 302. The key 302 may be inserted into the key hole 106. The key acceptor is of a small size, such that keys of a typical width cannot fit into the key acceptor 106, or the key hole. Thus, tools typically used to break into vehicles cannot be used to unlock a vehicle door equipped with a vehicle lock according to the present invention. In one embodiment, the diameter of the key acceptor is less than 1 inch, and in another embodiment, less than ½ inch, and in another embodiment, less than ⅓ inch. In a further embodiment, a height of the key hole 108 is less than ¾ inches, or less than ½ inch, or less than ⅓ inch, or less than ¼ inch, or less than ⅛ inch. In yet a further embodiment, the width of the key hole 108 is less than ⅓ inch, or less than ¼ inch, or less than ⅛ inch.

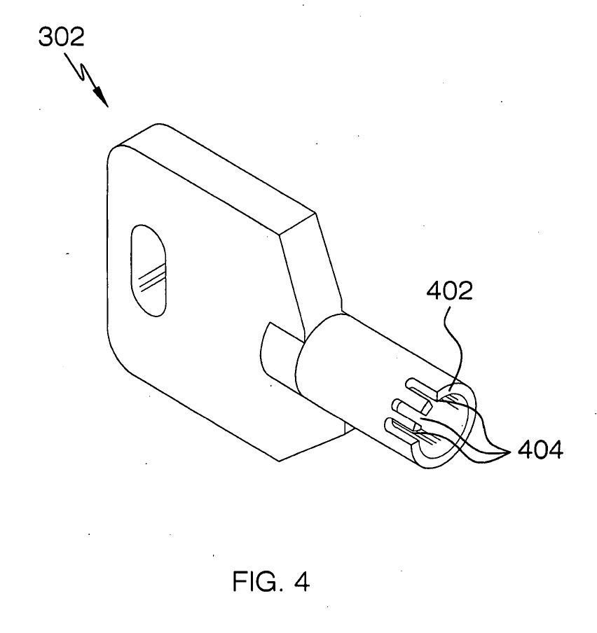

The key 302 may be tubular-shaped. The key 302 is further illustrated in FIG. 4. The key may include a tubular portion 402. The tubular portion may include cutaways 404 which fit the key acceptor 106. The cutaways 404 may vary in position, shape, size, and so forth such that different keys 302 fit different key acceptors 106.

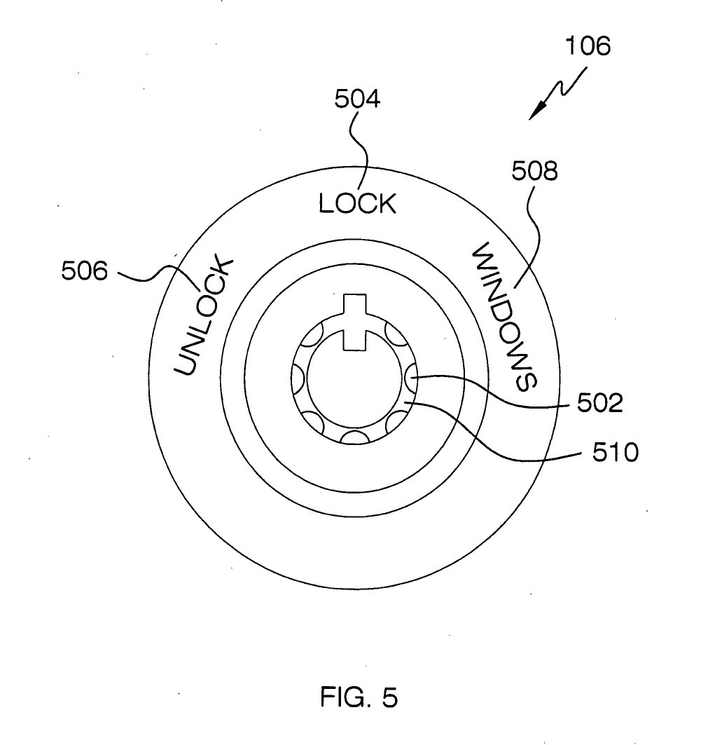

FIG. 5 illustrates a key acceptor 106 according to one embodiment of the present invention. The key acceptor 106 may include a substantially circular portion 510 configured to accept a tubular key 302. The circular portion 510 may include pins 502 which are configured to fit into the cutaways 404. The key acceptor 106 may be configured such that the acceptor does not allow rotation of the inserted key 106 when the cutaways 404 of the key do not match the pins 510 of the key acceptor 106.

The key acceptor 106 may allow for rotation of an inserted key to a number of positions 504, 506, 508 that correspond to different functions. For example, the key acceptor 106 may include an unlock position 506 where, if the key is turned to the unlock position 506 the lock 11 2 allows the door to be opened. The key acceptor may include a lock position 504 where, if the key 302 is turned to the lock position 506, the lock 112 does not allow the door to be opened. Further, there may be a windows position 508 where, if the key is turned to the window position 508, the windows of the vehicle automatically open or close.

In one embodiment, there is a vehicle lock kit. The kit may be assembled in the field to retrofit a vehicle with a vehicle lock of the present invention. The kit may include a key 302, a key acceptor 106 with a key hole 108, both according to any of the above embodiments. The kit may further include a spacer 110, that may be part of the key acceptor 106. The spacer 110 may be configured to fit a vehicle door and/or handle of a predetermined make and/or model of vehicle. For example, the kit sold for a Volkswagon Passat may include a different spacer than the kit sold for a Toyota Corrolla. The key acceptor may include a shaped portion 306. The shaped portion may include a cutaway 308. The kit may include a lock clip 202 configured to fit on the cutaway 308. The kit may include a link arm 104 and a lock arm 102 configured to manipulate the locking mechanism of the particular make and/or model of vehicle for which the kit is sold. For example, the kit sold for a Toyota Corrolla may include a link arm 104 and lock arm 102 configured to manipulate the locking mechanism of the Toyota Corrolla. Further, the kits may vary be the year of the vehicle for which the kit is designed. Further still, the kit may vary for the specific door of the vehicle for which the kit is designed.

In one embodiment, the only differences between various kits are the link arm 104, lock arm 102, the spacer 110, and the key 302. The kit may include several sets of pieces for each door of the vehicle, wherein all of the sets may function with a common key.

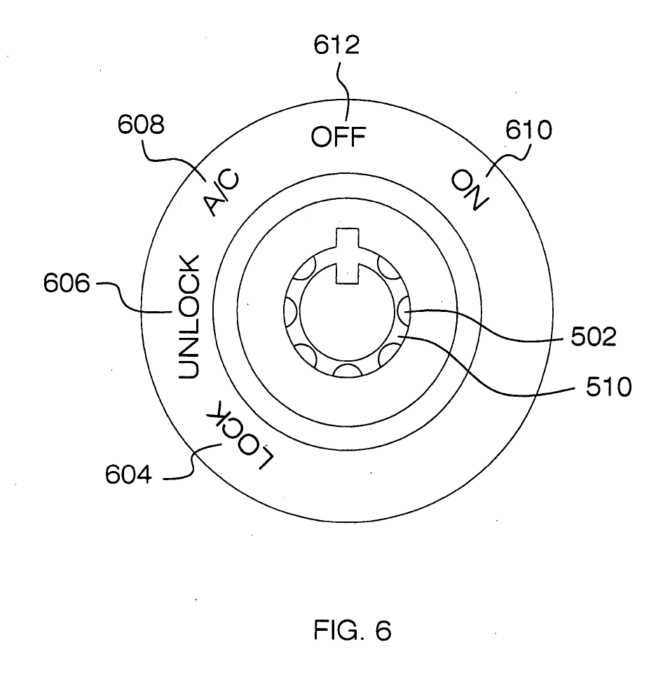

In another embodiment, the present invention may be used in the ignition switch of a vehicle to start an automobile. The key acceptor may replace the key acceptor of a typical vehicle ignition switch. FIG. 6 illustrates a vehicle lock according to the present embodiment. The vehicle lock includes a key acceptor 106. The key acceptor 106 may be configured to correspond with a key 302. The key acceptor 106 may allow for rotation of an inserted key to a number of positions 604, 606, 608, 610, 612 that correspond to different functions. For example, the key acceptor 106 may include an unlock position 606 where, if the key is turned to the unlock position 606 the lock 112 allows the door to be opened, and/or the steering wheel to be turned. The key acceptor may include a lock position 604 where, if the key 302 is turned to the lock position 604, the lock 112 does not allow the door to be opened and/or the steering wheel to be turned. Further, there may be a windows position 608 where, if the key is turned to the window position 608, the windows of the vehicle automatically open or close. There may also be a start position 610, where, if the key 302 is turned to the start position 610, the ignition switch causes the engine to start. There may further be an off position 612, where, if the key is turned to the off position 612, the ignition switch causes the engine to turn off.

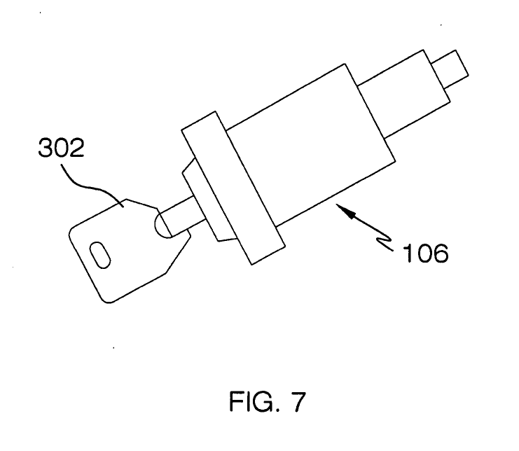

FIG. 7 illustrates a side plan view of the cylinder as it may be used in a vehicle ignition switch. The illustrated vehicle lock includes a key 302. The key may be configured to correspond to the key acceptor 106.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Finally, it is envisioned that the components of the device may be constructed of a variety of materials, such as, for example, metal, alloy, plastic, mineral, crystal, composite, fiber, wood, and the like.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

1. A vehicle lock for inhibiting unwanted intrusion into a vehicle, comprising:
a key acceptor which includes a hey hole for the insertion of a key, wherein the key acceptor has a diameter of less than ⅓ inch;
a spacer extending coaxially with the key acceptor, and encompassing at least a portion of the key acceptor;
a link arm rotatably connected to the key acceptor; and
a lock arm, connected to the key acceptor such that upon rotation of the link arm, the lock arm causes a locking mechanism to change between locked and unlocked positions.

2. The vehicle lock of claim 1, wherein the key acceptor is generally cylindrical in shape.

3. (canceled)

4. A vehicle lock kit that can be assembled in the field, for retrofitting vehicles with a vehicle lock mechanism for inhibiting unwanted intrusion into vehicles, the kit comprising:
a key acceptor which includes a hey hole for the insertion of a key, wherein the key acceptor has a diameter of less than ⅓ inch;
a spacer extending coaxially with the key acceptor, and encompassing at least a portion of the key acceptor;
a link arm rotatably connected to the key acceptor; and
a lock arm, connected to the key acceptor such that upon rotation of the link arm, the lock arm causes a locking mechanism to change between locked and unlocked positions.

5. The vehicle lock kit of claim 4, wherein the key acceptor is generally cylindrical in shape.

6. (canceled)

7. The vehicle lock kit of claim 4, wherein the key hole includes a height of less than about ⅓ inch.

8. The vehicle lock kit of claim 4, wherein the key acceptor includes a shaped portion that extends through the link arm.

9. The vehicle lock kit of claim 8, wherein the shaped portion further includes a cutaway, and wherein the kit further includes a lock clip that clips onto the cutaway portion.

10. The vehicle lock kit of claim 4, further including a key shaped to fit into the key hole.

11. The vehicle lock kit of claim 10, wherein the key is tubular.

12. A vehicle lock for inhibiting unwanted intrusion into a vehicle, consisting of:
a key acceptor which includes a hey hole for the insertion of a key, wherein the key acceptor has a diameter of less than ⅓ inch;
a spacer extending coaxially with the key acceptor, and encompassing at least a portion of the key acceptor;
a link arm rotatably connected to the key acceptor; and
a lock arm, connected to the key acceptor such that upon rotation of the link arm, the lock arm causes a locking mechanism to change between locked and unlocked positions.

13. The vehicle lock of claim 12, wherein the key acceptor is generally cylindrical in shape.

14. (canceled)

15. The vehicle lock of claim 12, wherein the key hole includes a height of less than about ⅓ inch.

16. The vehicle lock of claim 1, wherein the key hole includes a height of less than about ⅓ inch.
